(19) United States
(12) Patent Application Publication
(10) Pub. No.: US 2006/0033732 A1
(43) Pub. Date: Feb. 16, 2006

(54) Three-dimensional spatial image display apparatus and three-dimensional spatial image display method

(76) Inventors: Rieko Fukushima, Tokyo (JP); Yuzo Hirayama, Kanagawa-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/181,824

(22) Filed: Jul. 15, 2005

(30) Foreign Application Priority Data
Jul. 15, 2004 (JP) 2004-208131

(51) Int. Cl. G06T 15/00

(52) U.S. Cl. 345/419

(57) ABSTRACT

A three-dimensional spatial image display apparatus includes a three-dimensional image display including a two-dimensional image display and a beam controlling element, a retro-reflective screen, and an optical element. As a gazing point on the beam controller element of the 3-dimensional image display, the 3-dimensional spatial image is generated by displaying a parallax image acquired from a plurality of directions so that an observer can look only from the direction which corresponds to the acquisition direction.

### CROSS REFERENCE TO RELATED APPLICATION

This application is based upon and claims the benefit of priority from the prior Japanese Patent Application No. JP2004-208 131 filed on Jul. 15, 2004, the entire contents of which are incorporated herein by reference.

### FIELD OF THE INVENTION

The present invention relates to a 3-dimensional spatial image display and the 3-dimensional spatial image display method.

### DESCRIPTION OF THE RELATED ART

Although there are various systems of 3-dimensional image display technology, the following composition may be used when displaying a 3-dimensional image without glasses like a multi-view system, a holography, and an integral photography system (IP system). That is, 3-dimensional image display pixels are configured by a plurality of 2-dimensional image display pixels arranged 2-dimensionally, and a beam controlling element (parallax barrier) is arranged to a front side of the 2-dimensional image display. In the beam controlling element, an aperture designed so that only one 2-dimensional image display pixel could be taken out from 3-dimensional-image display pixels is arranged by every 3-dimensional image display pixel pitch.

The 3-dimensional image display pixels are partially interrupted by the beam controlling element, and a 3-dimensional image can be viewed without glasses because an observer makes the 2-dimensional image display pixels viewed through the apertures differ for every observation position. Especially in the case where the IP system is applied to an electronic device, liquid-crystal-display . . . etc., the system may be called an integral imaging system (II system). The II system will be explained as follows.

In the II system, the image displayed on the 3-dimensional image display pixel is called an element image. The element image is equivalent to a pinhole camera image photographed when the aperture is replaced to a pinhole. However, in the present condition, compared with a silver halide film of the pinhole camera, the resolution of the electronic device is low, and the element image is an only set of pixels which constitutes a plurality of 2-dimensional images changed a photographing angle. That is, the element image displayed on each 3-dimensional-image display pixel is a set of the components of the 2-dimensional images (parallax image) photographed from a plurality of different directions, and a pixel information corresponding to an observer's observation direction among this set, i.e., a 2-dimensional pixel information which should be in sight when a 3-dimensional image actually exists, is viewed by the observer via the aperture.

The difference between the multi-view system and the II system is caused by the lowness of the resolution of the electronic device. Ideally, although the photographing angle of the element images should be continuous, it becomes discrete from the insufficient resolution of the electronic device. The multi-view system is designed so that the lines which connect the aperture and the pixel, i.e., light rays emitted via the aperture may condense at a viewing distance. The II system does not condense at the viewing distance.

In order to explain the principle of the multi-view system, a binocular system is explained first. The binocular system is a 3-dimensional image display system which is designed so that 2-dimensional images acquired by the perspective projection in each photographing position condense at a pair of points that has a distance between eyes (for example, 63 mm). According to this design, the observer can look at separate images (each 2-dimensional image photographed in two photography positions) by the right eye and the left eye in the position which is a certain observation viewing distance from the screen, without glasses. The case where a plurality of these condensing points is put in horizontally is the multi-view system. Since both of the images observed by the right eye and the left eye change according to the observation position moving horizontally by increase of the condensing point, the observer can check changes of the 3-dimensional image according to movement of the observation position.

On the other hand, the feature of the II system is making it the 2-dimensional image photographed in each photographing position not condensed to one point near the viewing distance. For example, the image acquired from the observation position of the observer in an infinite distance from the screen is designed so that it may change for every observation position. In a typical example, the II system is designed so that the light rays emitted from different apertures may be parallel, and the 3-dimensional image can be created from the image photographed by the parallel-projection. Since the observer's observation distance is actually limited according to such a design, the 2-dimensional image observed by the one eye is not equal to the 2-dimensional image photographed in each photographing position. However, each of the 2-dimensional images observed by the right eye and the 2-dimensional image observed by the left eye is a 2-dimensional image photographed from the observation position by the perspective projection on an average, since the 2-dimensional image is configured by the composition of images photographed by the parallel projection from a plurality of directions. Consequently, the observer can see separate images by the right eye and the left eye, the 3-dimensional image which the observer can see is equal to the 3-dimensional image recognized when the photographed object is actually observed from each direction. That is, an observation position is not assumed by the II system. Consequently, natural movement parallax is acquired from the both of the images observed by the right eye and the left eye changing continuously according to the observation position moving horizontally.

But, as the II system uses a lenticular sheet, in the one-dimensional II system given only horizontal parallax, in order to really see the 3-dimensional image in perspective projection, a horizontal parallax image needs to be created by the parallel projection, and a vertical parallax image needs to be created by the perspective projection. Consequently, although the observer can view the 3-dimensional image without distortion in distant viewing, a vertical direction of the 3-dimensional image observed includes distortion, if the distant viewing shifts to front and rear. Therefore, when an observable viewing area of the 3-dimensional image without distortion is expanded to front and rear directions, a 2-dimensional II system is suitable. However, in the one-dimensional II system, even if the distant viewing shifts to front and rear to some extent, it is known to be able to observe the 3-dimensional image unconscious of distortion.

When the 3-dimensional image viewing area in the 3-dimensional image display of this II system is expressed qualitatively, the Nyquist frequency of the aperture on a screen is the highest spatial resolution in the 3-dimensional display which can be displayed, and the highest resolution of the 3-dimensional image displayed on space of depth and forward direction on the basis of the screen top has a tendency to decrease according to leaving from on the screen (see H. Hoshino, et al., J. Opt. Soc. Am. A., 15, 2059(1998)). If the 3-dimensional image is displayed over the viewing area, since the parallax image information acquired from a different direction will dissociate, the observer will not see a 3-dimensional image but a double image.

In the multi-view system, the 3-dimensional display using a projector and a retro-reflective screen is proposed. Here, the retro-reflective screen has a function to reflect the light reversed along a locus of the incident light ray, and specifically, a sheet having cube corner reflectors, a resin bead sheet, and a sheet having a diffusion reflective board in the focal plane of rear of fly's-eye lens, etc. are mentioned. A plurality of projectors arranged at a distance between both eyes and the retro-reflective screen confront each other, reflective light rays which are ejected from the projector and return to the projector from the retro-reflective screen condense into the light ejection portions (i.e., lens) of the projector if arrangement of the retro-reflective screen and the projector remains as it is. However, because of a low degree of reflectivity, and the condensing points of the reflective light rays are shifted or expanded from the light emitting portion, the observer can view the 3-dimension image with both eyes by binocular parallax. When the 3-dimensional image projects from 3 or more projectors, movement parallax is also given although it is discontinuous to this.

Although the IP system was developed as a stereograph, when the 3-dimensional image was displayed by combining the printing paper printed over the micro lens array and the original lens, there was a problem that an unevenness of photographed object was reversed (reverse stereoscopic vision). In order to originate in the image given by the IP system being a real image and to reproduce a real image in the original position correctly, an inside-out image was projected to the observer. On the other hand, there is a method of a retro-reflective screen being confronted with the 3-dimensional-image display of the IP system which displayed the inside-out image, reflection light rays being taken out by a half mirror, and displaying the image which corrected unevenness. (see C. B. Burckhardt, et al., Appl. Opt., 7(3) 627 (1968)).

However, since the above-mentioned photo image was aimed at the object arranged in the front from the display, the display position of the 3-dimensional image was restricted from the display side to the front, i.e. the viewing area resolution decreased.

### SUMMARY OF THE INVENTION

A three-dimensional spatial image display apparatus according to an embodiment of the invention includes a three-dimensional image display having a two-dimensional image display configured to display pixels arranged in a matrix shape, the pixels composing an elemental image, the three-dimensional image display further having a beam controlling element arranged parallel to a display surface of the two-dimensional image display and having apertures corresponding to the pixels, and the three-dimensional image display being further configured to display a three-dimensional image by emitting light rays from the pixels via the apertures corresponding to the pixels; a retro-reflective screen configured to reflect the light rays along a locus of the light rays emitted from the pixels via the apertures corresponding to the pixels; and an optical element arranged between the beam controlling element and the retro-reflective screen, and being both transmissive and reflective so as to cross the locus of the light rays.

A method of displaying three-dimensional spatial imaging according to an embodiment of the invention includes displaying pixels arranged in a matrix shape, the pixels composing an elemental image by a two-dimensional display, reflecting light rays emitted via an aperture of a beam controlling element arranged parallel to a display surface of the two-dimensional image display and providing apertures corresponding to the pixels, along a locus of the light rays emitted from the pixels by a retro-reflective screen; arranging an optical element between the beam controlling element and the retro-reflective screen; and displaying a three-dimensional image from light rays emitted via the aperture by an optical element which is both transmissive and reflective so as to cross the locus of the light rays and light rays reflected by the retro-reflective screen.

### BRIEF DESCRIPTION OF THE DRAWINGS

The invention is best understood from the following detailed description when read in conjunction with the accompanying drawings.

FIG. 1 is a view showing a 3-dimensional image displayed by a 3-dimensional image display apparatus.

FIG. 2 is a view showing a constitution according to a 1st embodiment of the 3-dimensional spatial image display apparatus.

FIG. 3 is a view showing a 3-dimensional-image observable area of the 3-dimensional image display apparatus.

FIG. 4 is a view explaining a viewing area of the 3-dimensional spatial image display apparatus.

FIG. 5 is a view showing a viewing area of the 3-dimensional spatial image display apparatus.

FIG. 6 is a view showing a screen size of the 3-dimensional spatial image display apparatus.

FIG. 7 is a view showing a screen size of the 3-dimensional spatial image display apparatus.

FIG. 8 is a view showing a screen size of the 3-dimensional spatial image display apparatus.

FIG. 9 is a support view for calculating the screen size of the 3-dimensional spatial image display apparatus.

FIG. 10 is a view showing a concept of a creation of element images.

FIG. 11 is a view showing a concept of a creation of element images.

FIG. 12 is a view showing a concept of a creation of element images according to the first embodiment of the 3-dimensional spatial image display apparatus.

FIG. 13 is a view showing a constitution according to a 2nd embodiment of the 3-dimensional spatial image display apparatus.

FIG. 14 is a view showing a constitution according to a 3rd embodiment of the 3-dimensional spatial image display apparatus.

FIG. 15 is a view showing a constitution according to a 4th embodiment of the 3-dimensional spatial image display apparatus.

FIG. 16 is a view showing a constitution according to a 5th embodiment of the 3-dimensional spatial image display apparatus.

FIG. 17 is a view showing a constitution according to a 6th embodiment of the 3-dimensional spatial image display apparatus.

FIG. 18 is a view showing a constitution according to a 6th embodiment of the 3-dimensional spatial image display apparatus.

FIG. 19 is a view showing a constitution according to a 7th embodiment of the 3-dimensional spatial image display apparatus.

FIG. 20 is a view showing a constitution according to an 8th embodiment of the 3-dimensional spatial image display apparatus.

### DETAILED DESCRIPTION OF EMBODIMENTS

Embodiments of a three-dimensional spatial image display apparatus consistent with the present invention will be described below in detail with reference to the accompanying drawing. For simplification of explanation, in figures, the same reference number will be used to refer to the same or like parts.

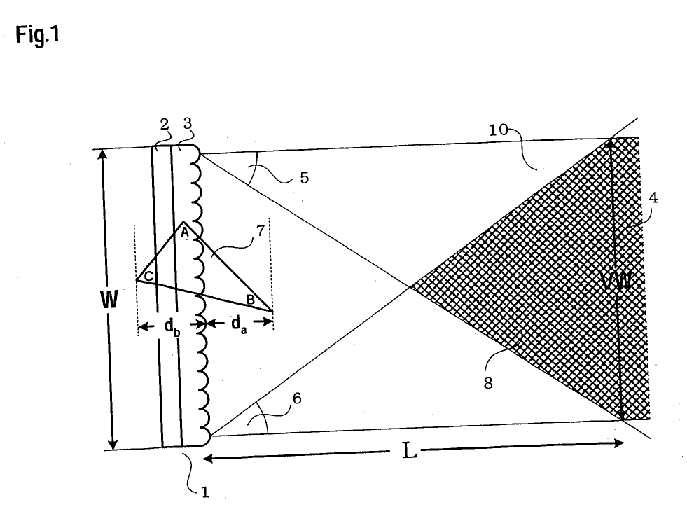

A horizontal cross section of a 3-dimensional image display is shown in FIG. 1. The 3-dimensional image display 1 shown in FIG. 1 has a 2-dimensional image display 2 which consists of, e.g., a liquid crystal panel, and a beam controlling element 3 which consists of, e.g., a lenticular. A horizontal width of the 3-dimensional image display 1 is W, and an observable area of 3-dimensional image in the 3-dimensional image display 1 is shown as viewing distance L and as viewing width VW (4) at the viewing distance L. An area occupied by light rays which emit from apertures (lens) of both ends of the beam controlling element is shown as 5, 6, respectively. Since the 3-dimensional image display is designed so that as light rays emitted from all apertures pass the viewing width VW (4) on the viewing distance L, the light rays emitted from all apertures fill area (viewing area 8) composed of overlapping light ray areas 5 and 6 emitted from lens of both ends. If an observer's binocular are located in a viewing area 8, the 3-dimension image displayed fully in the 3-dimensional image display 1 is correctly observable. Furthermore, when explained in detail, the area which the light rays emitted from the element image arranged corresponding to each aperture fills, is the viewing area 8, when the observer is located in the area which is separated from the viewing area 8, a different 3-dimensional image (false image) from the 3-dimensional image which should be observed essentially is observed by viewing the light rays passed via aperture which adjoined the original aperture.

When the 3-dimensional-image display 1 is the multi-view system, the viewing area 8 shown in FIG. 1 can be realized by designing so that a condensing point may be arranged on at viewing distance L. Specifically, the aperture pitch is narrowly designed a little from the width of the pixels by which the image corresponding to each aperture was displayed. That is, the line which connects the corresponding aperture to the center of each of the pixels crosses once on the viewing distance, and an area 4 (viewing area width VW) which can observe a 3-dimensional image is maximized.

On the other hand, when it is the II system of the feature that light rays are dispersed, although a width of the pixels as to which the image corresponding to each aperture is displayed on the multi-view system cannot be made into one value, the width of the pixels corresponding to each aperture is adjusted in a pixel width, and the line which connects a corresponding aperture to the center of pixels that the image corresponding to each aperture is displayed can be designed, so that it may cross approximately by one on the viewing distance L. Thereby, like the case of the multi-view system, while carrying out incidence of the light rays emitted from all apertures in the width of viewing area 4(VW) on viewing distance L and maximizing it, viewing area 8 is realized.

The above is the definition of the viewing area in the case of viewing the 3-dimensional picture display 1 directly, and also mentions the viewing area of the 3-dimensional spatial image display of the case of the embodiment. The 2-dimensional image display 2 may be a liquid crystal display, a plasma display, field emission type display, organic electroluminescence display, etc., of a direct viewing type or a projection type, if the pixel from which the position was determined in the screen is arranged in a matrix shape. The slit or lenticular sheet extends to the outline in a perpendicular direction and a periodic structure in an outline horizontal direction is used as a beam controller element 3. Following a drawing is a horizontal cross view using a lenticular sheet, shows the composition which does not have parallax perpendicularly, and shows a composition which has parallax horizontally. However, this lenticular sheet may be a lenticular sheet which may be replaced by a lens array which has also parallax perpendicularly, and may be a lenticular sheet which has only parallax perpendicularly. Moreover, since the width of the viewing area in a viewing distance L is perpendicular to FIG. 1 in the case of the latter, explanation is omitted here.

A triangle 7 shows notionally the 3-dimension image displayed on the 3-dimensional image display 1. Among 3 vertices of the triangle 7, B is displayed in projection direction, A is displayed on a screen, and C is displayed in the depth direction. Distance ‘da’ of the drawing shows a projection limit of the 3-dimensional image (is not observed as double image), and ‘db’ shows a depth limit of the 3-dimensional image. Distances ‘da’ and ‘db’ are calculated from a value which corresponds to the design of the 3-dimensional image display 1, and the spatial frequency of the 3-dimensional image 7 displayed.

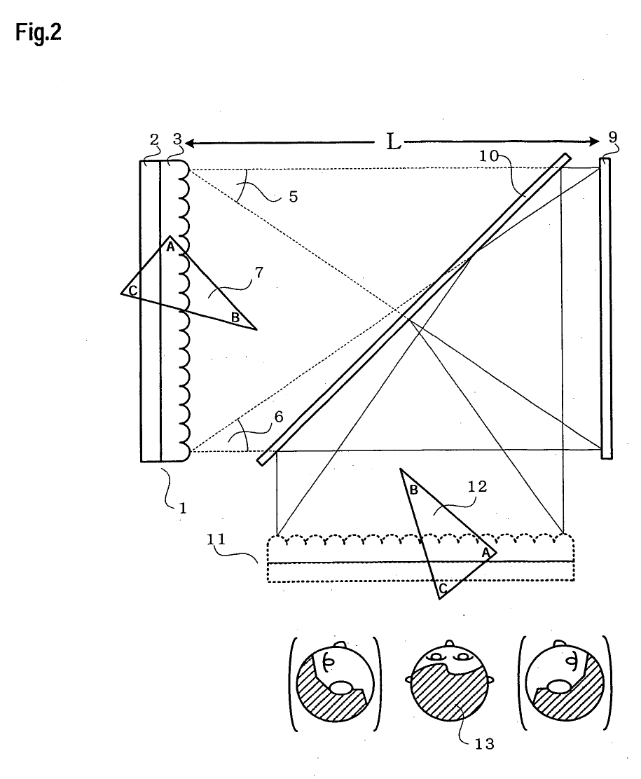

Next, a 3-dimensional spatial image display is explained with reference to FIG. 2. FIG. 2 shows an arrangement of the 3-dimensional spatial image display. A retro-reflective screen 9 is arranged in a position applicable to the viewing distance L and the viewing area 4 which is decided from the design of the 3-dimensional-image display 1, and all the light rays which display a 3-dimensional image reverse along a locus of the light rays emitted from the 3-dimensional image display l. The 3-dimensional image (triangle 7) displayed on the 3-dimensional-image display 1 can be displayed in the face of an observer 13 as a 3-dimensional spatial image 12 according to taking out the light rays and the reversed light rays in an optical element 10 which is both transmissive and reflective, such as a half mirror and a polarizing prism, etc. . . . In order to make it intelligible, the position corresponding to the 3-dimensional-image display 1 is shown by 11. The position where the 3-dimensional image is displayed in the highest resolution as shown in FIG. 1 is on the screen of the 3-dimensional image display 1. However, according to a structure shown in FIG. 2, the 3-dimensional image displayed in the highest resolution is in a position wherein the image is moved into the face of the observer 13. Furthermore, C displayed in the screen and A displayed on a screen are taken out in space. Moreover, as mentioned above, when the parallax information on the 3-dimensional image display 1 is given not only a parallel direction to the drawing in FIG. 1 but a perpendicular direction to the drawing or is given only the perpendicular direction to the drawing, the observer 13 can view the 3-dimensional image at the angle shown in the parentheses of FIG. 2. That is, as shown in FIG. 2, the arrangement of the 3-dimensional image display 1, the retro-reflective screen 9, and the optical element 10 may be horizontal for the observer 13, and, as the observer 13 shown in the parentheses of FIG. 2, may be perpendicular for the observer 13.

The structure of FIG. 2 differs from the projection multi-view system display which combined the projector and the retro-reflective screen fundamentally in respect of the following. That is, in the projection multi-view system display, the retro-reflective screen is equivalent to the display, and as a gazing point (no parallax) on the retro-reflective screen, a parallax image acquired from a plurality of directions is displayed so that the observer can view only from the direction which corresponds to the acquisition direction. However, in the 3-dimensional spatial image display shown FIG. 2, as a gazing point on the beam controller element 3 of the 3-dimensional image display 1, the 3-dimensional spatial image is generated by being displayed as a parallax image acquired from a plurality of directions so that the observer can view only from the direction which corresponds to the acquisition direction.

Next, a difference between the 3-dimensional image 7 and the 3-dimensional spatial image 12 in FIG. 2 is explained. C located in the most back side in the 3-dimensional image 7 is located in the most front side in the 3-dimensional spatial image 12. Moreover, right and left of the 3-dimensional spatial image 12 and the 3-dimensional image 7 are the same. That is, when the observer observes the 3-dimensional image 7, and also when the observer observes the 3-dimensional spatial image 12, A is the rightmost and B is the leftmost from the viewpoint of an observer. This is because the 3-dimensional spatial image 12 is displayed by reflecting the light rays twice in the retro-reflective screen 9 and the optical element 10, and an advance direction of the light ray is reversed by the retro-reflective screen 9, as compared with a 3-dimensional image 7.

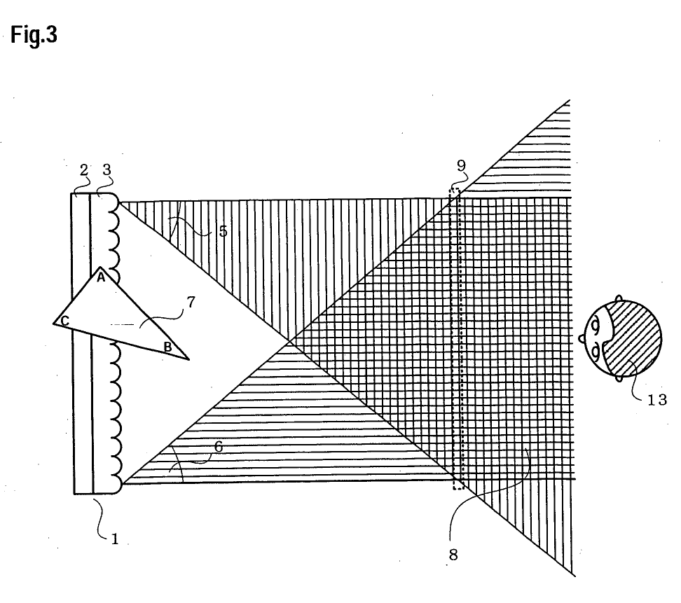

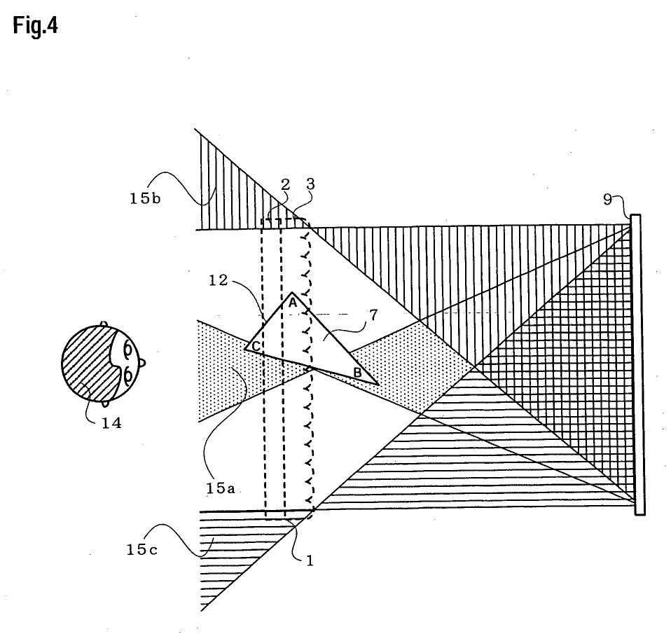

The observable area and resolution of the 3-dimensional spatial image 12 are explained. FIG. 3 explains the viewing area in the case of viewing the 3-dimensional image 7 displayed on the 3-dimensional-image display 1. An area 8 which the light rays 5 and 6 emitted from the lens of both ends of the 3-dimensional-image display 1 fill, is the viewing area in which the 3-dimensional image 7 is observable. On the other hand, the viewing area in the 3-dimensional spatial image display of this embodiment is explained using FIG. 4. An area in which the assumptive observer 14 can observe the 3-dimensional image 7 from the back of the 3-dimensional image display 1 is equivalent to a viewing area of the 3-dimensional spatial image 12 (since there is reflection once as compared with the 3-dimensional image 7, right and left are reversed). Since light rays incident to the retro-reflective screen 9 only reflect among all the light rays emitted from the 3-dimensional-image display 1, all the reflection light rays emitted from the retro-reflective screen 9 are light rays incident along the width W of the 3-dimensional image display 1. However, if the 3-dimensional spatial image displayed on 3-dimensional spatial image display 1 is observed, the observer can observe a 3-dimensional image 7, without a screen. Therefore, the viewing area of the 3-dimensional spatial image 12 is considered as an area in which the reflection light rays emitted back from each element image displayed on the 3-dimensional-image display fill. The area which these reflection light rays occupy is shown in FIG. 4 as, for example, three areas 15a-15c which the light rays occupy.

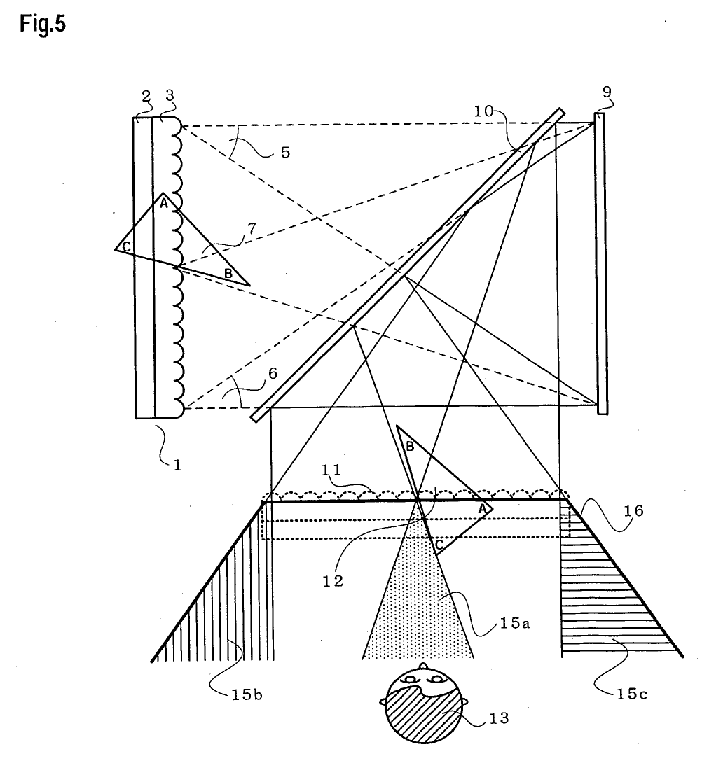

Since the reflection light rays of the light rays emitted from each aperture is emitted to diffusion, an area in which the light rays emitted from all element image overlap and are incident is especially restricted depending on the assumptive observer's 14 position. The area is restricted when the assumptive observer 14 observes from the position near the display back. That is, in the position near the 3-dimensional image 7, the right element image can not be observed via all apertures. Although viewing the element image which adjoins the element image which should be observed via the aperture is similar to the original 3-dimensional image which is displayed, the light rays via the aperture which adjoined the original aperture may cause a false image including distortion. Here, the viewing area of the 3-dimensional spatial image display is shown in FIG. 5. Although the incidence area of the reflection light from the retro-reflective screen 9 is an area shown by the segment 16, the areas on which the correct 3-dimensional image is displayed are 15a-15c.

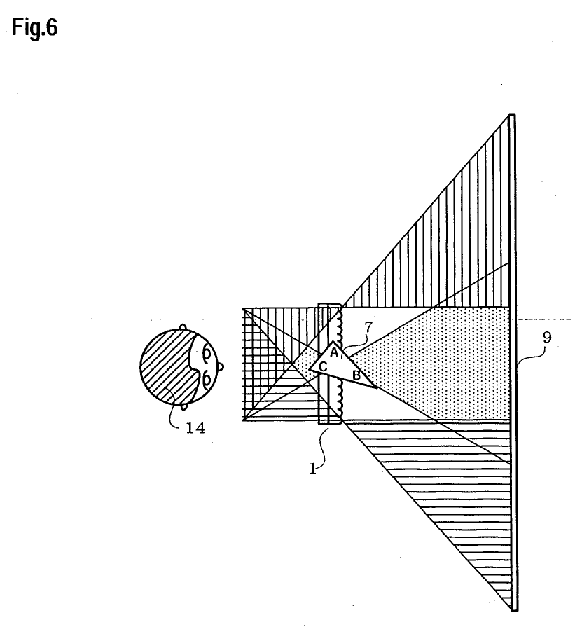

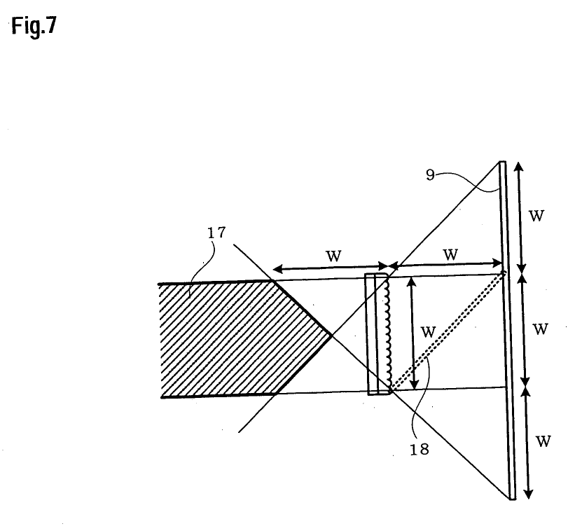

If an assumptive apparatus which observes the 3-dimensional image 7 from the back is explained, in order to secure the viewing area of 3-dimensional spatial image display, as shown in FIG. 6, a screen 9 of larger area than the 3-dimensional image display 1 is prepared. Although a larger light generating system than the 3-dimensional spatial image displayed is needed in order to reproduce the scattered light rays of the 3-dimensional image when it is generally going to reproduce the 3-dimensional spatial image in front of the observer which is detached greatly from a display system, this embodiment may be needed depending on the case. A manner in which a screen width and element image width may be defined is explained with reference to FIG. 7-FIG. 9

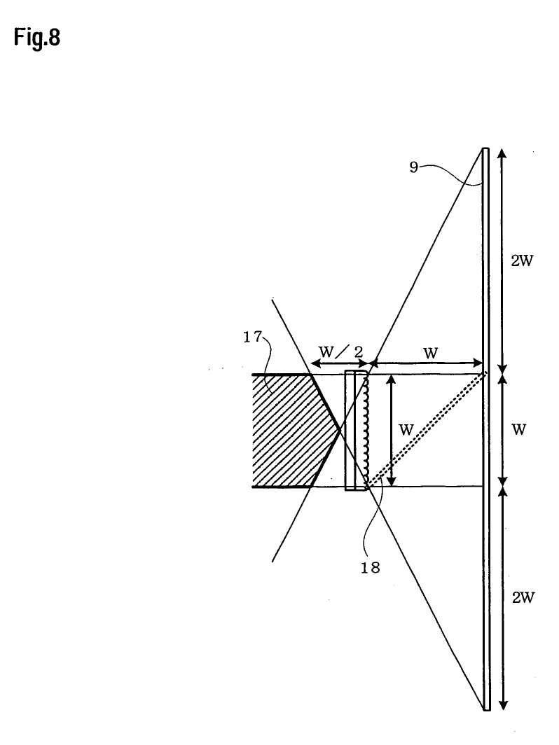

The case of a screen width of the 3-dimensional-image display 1: W=a distance between the 3-dimensional image display 1 and the retro-reflective screen 9=a viewing area setting distance of the 3-dimensional spatial image 12 is shown in FIG. 7. A horizontal width of the retro-reflective screen three times as long as the screen width is necessary for the 3-dimensional image display in order to maximize a width of viewing area in the viewing area setting distance of the 3-dimensional spatial image 12. The structure in case of making the viewing distance of the 3-dimensional spatial image into W/2 similarly is shown in FIG. 8. If the viewing distance is shortened, the retro-reflective screen with a wider horizontal width is needed. However, when a screen width becomes larger than the distance between the 3-dimensional image display 1 and retro-reflective screens 9, an arrangement of the optical element is more difficult. Therefore, the distance between the 3-dimensional-image display 1 and retro-reflective screens 9: L equal to the horizontal width of the retro-reflective screen is designed. In this case, a viewing distance (X) in which the 3-dimensional spatial image 12 can be observed without mixing a false image is found in the following procedures.

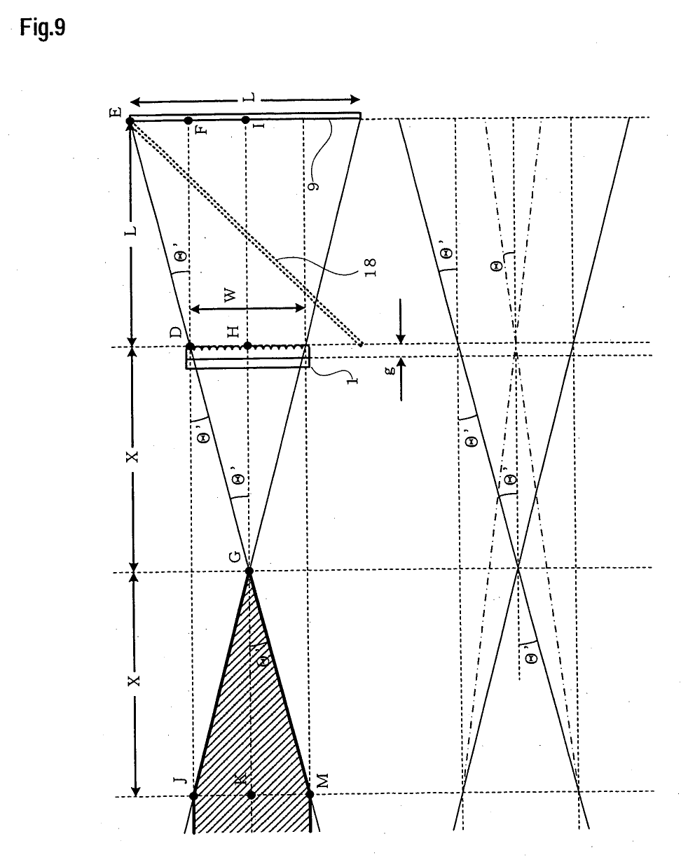

In FIG. 9, the distance between the 3-dimensional image display 1 and retro-reflective screens 9: L equal to the screen width, angle EDF (θ′) is defined by the following formula (1):
tan θ′=(L−W)/2L (1):
angle θ′ is equal to angle DGH in which the perpendicular taken down to the center H on the back of the 3-dimensional-image display from the center G of the width of the viewing area in the viewing distance X of the 3-dimensional spatial image, and the line which connects the 3-dimensional image display edge D to the center G of the width of the viewing area.
tan θ=W/2X (2)
Formula (2) is given as above. θ′ is equal to angle DGH and angle JGK. The nearest distance (X) in which the 3-dimensional spatial image 12 can be observed without mixing of a false image is shown in formula (3) according to formula (1) and (2).
X=LW/(L−W) (3)
Therefore, the distance (L′) of which the reflection light rays from all element images is incident is shown in formula (4):
L′=2X=2LW/(L−W) (4)
The width (JM) of reflection light rays incident in L′ is equal to the screen width (W). The element image width (w) in such a design, when the aperture pitch in the beam controller element is pe, pe is calculated by the following formula (5):

$$\begin{matrix}X : ( X - g ) = pe : w \\ w = pe ( X - g ) / X \\ = pe \{ 1 - g ( L - W ) / LW \}\end{matrix} \qquad ( 5 )$$

In the design of above, if an angle of the light ray in the element image which emits from the lens in nearly the center of the beam controller element is 0, the gap (g) between the aperture and the display screen is shown in the following formula (6):
tan θ=w/2g=W/4X=(L−W)/4L (6)
g=2wL/(L−W) (7)
It is necessary to design according to formula (6) and (7). Therefore,
θ=arctan (w/2g)=arctan {(L−W)/4L} (8)
According to the formula (6),
w=g(L−W)/2L (9)
According to the formula (5) and (6),
g(L−W)/2L=pe {1−g(L−W)/LW}
g=2Lpe/{(L−W) (1+2pe/W)} (10)

### First Embodiment

In the case where the 2-dimensional image display 2 is a liquid crystal display, the beam controller element 3 is arranged in front of the 2-dimensional image display 2, and backlight (not shown) is arranged in the rear of the 2-dimensional image display 2. Specifically, QUXGA-LCD panels (3200×2400 pixels, image-field 422.4 mm×316.8 mm, etc.) are used as a liquid crystal display. In this liquid crystal display, sub pixels of three shades of red, green and blue can be driven independently. For example, a horizontal length of each sub pixel of red, green and blue is 44 micrometers, and a perpendicular length is 132 micrometers. The color filter is in a stripe arrangement. In addition, in the usual 2-dimensional image display 2, although one pixel (triplet) is constituted from 3 sub pixels of red, green and blue which are horizontally located in a line, it is explained by using the structure in which these restrictions are canceled in this embodiment.

The beam controller element 3 uses the lenticular sheet designed so that a pixel position of a liquid crystal panel corresponds nearly with a focal length. That is, this embodiment uses structure which gives parallax information for only a horizontal direction. In an ideal structure of the 3-dimensional image display 1 in this embodiment, the pixel of the 2-dimensional image display 2 corresponds with the focal position of a lens. Thereby, the light rays emitted from the infinitesimal position on a pixel emits in parallel. Since a sub pixel width is limited, the light ray emitted from a single sub pixel emits with a breadth according to the sub pixel width)¥. In this condition, the lenticular sheet consists of PMMA (Poly methyl methacrylate, acrylic resin).

A distribution of the element image displayed on the 2-dimensional image display 2 in order to maximize the viewing area of the 3-dimensional spatial image 12 differs from the rule which maximizes the viewing area in the case of viewing the 3-dimensional image display 1.

First, according to the viewing distance (L)=retro-reflective screen width=633.6 mm, the following formula is shown by using the formula (3).

$$\begin{matrix}X [ mm ] = 633.6 \times 422.4 / ( 633.6 - 422.4 ) \\ = 1267.2 .\end{matrix}$$

Moreover, since the lens pitch is as long as 16 times of a sub pixel pitch, the horizontal number of the sub pixels which constitute an element image is 16 pieces fundamentally, is 15 pieces discretely, and is a little less than 16 pieces on the average. Specifically, according to the formula (6):

$$\begin{matrix}tan θ = ( 633.6 - 422.4 ) / 4 \times 633.6 \\ = 1 / 12 \\ θ = about 4.8 degree\end{matrix}$$

According to the formula (10):

$$\begin{matrix}g = 2 \times 633.6 \times 0.704 / ( 633.6 - 422.4 ) ( 1 + 2 \times 0.704 / 422.4 ) \\ = 892.1 / ( 211.2 \times 1.003 ) \\ = 4.2 mm\end{matrix}$$

Therefore, according to the formula (9):

$$\begin{matrix}w = g ( L - W ) / 2 L \\ = 0.702 mm ( = 15.95 parallax ) .\end{matrix}$$

That is, it is arranged so that the average element image width is 15.95 and one element image per 320 element images that consists of 16 pieces, and the one element image consists of 15 pieces. Thereby, although the element image average width (w) is narrower than the aperture pitch (pe) of the lenticular sheet, and each of the light rays via the adjoining lens has a parallel relation, the viewing area (area which does not observe a false image) of the 3-dimensional spatial image 12 in the 3-dimensional spatial image display is wider.

If the material of a lens is set to be acrylic (n=1.49), a distance between principal points (h) is calculated by the following formula (11):

$$\begin{matrix}h = lens thickness ( 1 - 1 / n ) \\ = g ( 1 - 1 / n ) \\ = 4.2 ( 1 - 1 / 1.49 ) \\ = 1.4 mm\end{matrix} \qquad ( 11 )$$

Therefore, a focal length (f) is calculated in the following formula (12):

$$\begin{matrix}f = g - h \\ = 4.2 - 1.4 \\ = 2.8 mm\end{matrix} \qquad ( 12 )$$

The radius of curvature of a lens is calculated in the following formula (13), according to the formula of a lens:

$$\begin{matrix}r = ( n - 1 ) f \\ = ( 1.49 - 1 ) \times 2.8 \\ = 1.4 mm\end{matrix} \qquad ( 13 )$$

As mentioned above, if the horizontal pitch of a lens is as long as an integral multiple of a horizontal width of the sub pixel, the direction (a locus of light rays) where the light ray emitted from each pixel observed via a lens has a parallel relation with adjoining apertures, and the point at which the light rays emitted from all the apertures condenses does not generate, in the distance which sets up the retro-reflective screen 9. That is, 3-dimensional image display 1 is explained as the II system in this embodiment.

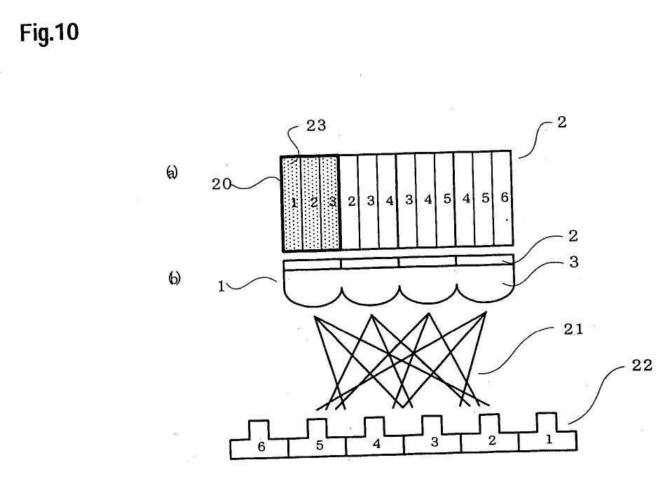

Here, an image acquisition direction of the element image of contents displayed on a direct-viewing-type 3-dimensional image display and a relation (concept) of mapping are shown in FIG. 10-FIG. 12.

FIG. 10(a) is a view showing the screen of the image display unit 4 which consists of four element images 20 which each constitutes three parallax images 23. FIG. 10(b) is a horizontal cross-sectional view of the 3-dimensional image display showing the relation between the image acquisition position 22 and the aperture 3. In addition, in FIG. 10(a), a number is assigned to each parallax image 23 to serve as a parallax image number.

For example, shown in FIG. 10(a), the element image 20 of the leftmost side which display on the screen of the display unit 2 has the parallax image 23 of parallax image numbers 1, 2, and 3 from left, the 2nd element picture 20 from left has the parallax image 23 of parallax image numbers 2, 3, and 4 from left, the 3rd element image 20 from left has the parallax image 23 of parallax image numbers 3, 4, and 5 from left, and the 4th element picture 20 from left has the parallax image 23 of parallax image numbers 4, 5, and 6 from left.

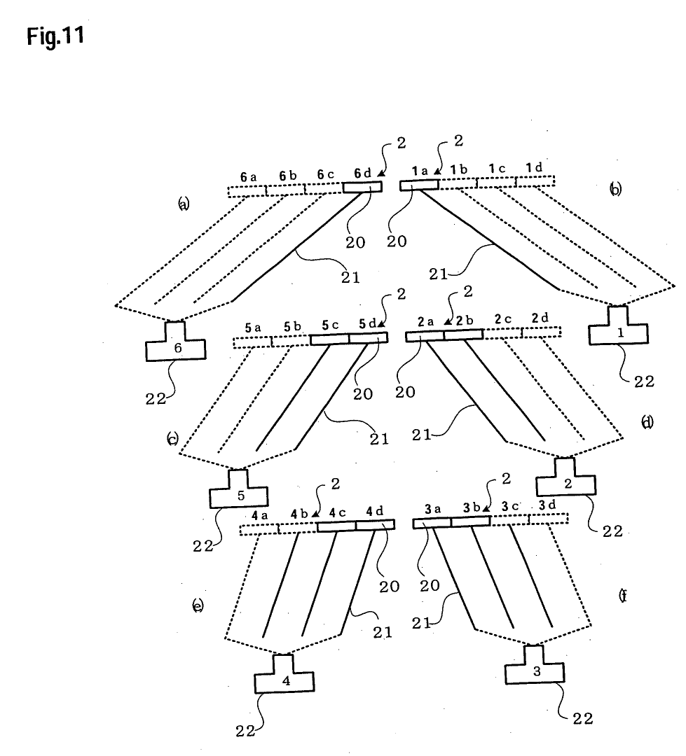

In FIG. 10(b), light rays 21 connect the aperture 3 to a center of the parallax image, and are also the direction from which the corresponding parallax image is acquired. The light rays via the adjoining aperture have a parallel relation, so that an element image can be created from parallel-projection images. A number assigned in the image acquisition position 22 is a parallel-projection parallax image number, and is equivalent to, i.e., a camera number which acquired this parallel-projection image. The image acquisition position corresponding to the parallax image number 6 is shown in FIG. 11(a), the image acquisition position corresponding to the parallax image number 1 is shown in FIG. 11(b), the image acquisition position corresponding to the parallax image number 5 is shown in FIG. 11(c), the image acquisition position corresponding to the parallax image number 2 is shown in FIG. 11(d), the image acquisition position corresponding to the parallax image number 4 is shown in FIG. 11(e), and the image acquisition position corresponding to the parallax image number 3 is shown in FIG. 11(f). For example, as shown in FIG. 11(a), the 1st, the 2nd, and the 3rd element picture 20 from the right side of the display unit 2 are constituted by using the parallax image of the parallel-projection parallax image number 4.

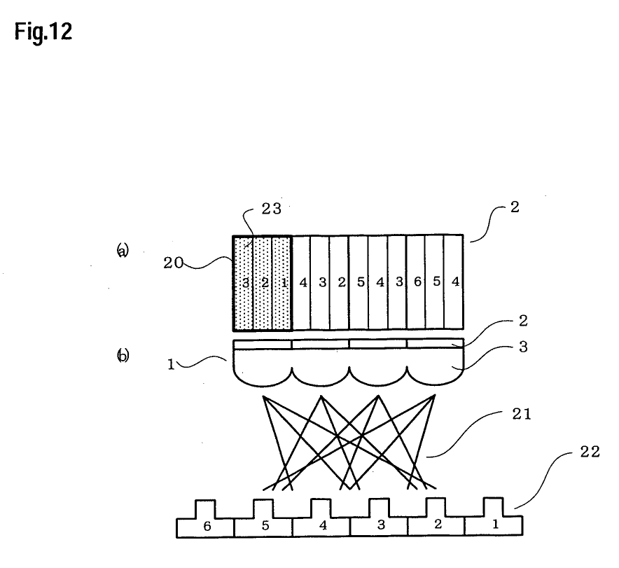

As shown in FIG. 2, the 3-dimensional spatial image 12 needs to reverse an unevenness of the 3-dimensional image 7, in order to obtain the 3-dimensional spatial image 12, since the 3-dimensional spatial image 12 is displayed with the unevenness which reversed the unevenness in the 3-dimensional image 7. That is, the unevenness of the 3-dimensional spatial image 12 is corrected by displaying the element images (FIG. 12) which are arranged to reverse symmetrically about the center of the element image relative to the contents (FIG. 10) displayed when the observer views the 3-dimensional image display 1. Although FIG. 12 shows the example which creates the element image from a plurality of camera images (parallax picture) which shift the image acquisition position, when element images are created, it can be applied by setting an image sensor on the 2-dimensional image screen, in similar or equivalent composition to the 3-dimensional image display 1.

Thereby, although it is known that the unevenness is reversed since the 3-dimensional image 7 displayed is a real image, if the acquired element image is used for a display as it is, the 3-dimensional spatial image displayed by using this element image has right unevenness. That is, since on-the-spot photo contents can be displayed as a 3-dimensional image as it is, a real-time display becomes easy.

Specifically, as the retro-reflective screen 9, a sheet arranged with cube corner reflectors, a resin bead sheet, and a sheet arranged with a diffusion reflective board in the focal plane of rear of fly's-eye lens, etc. are possible. The retro-reflection is realized by above the structures. Between the 3-dimensional image display 1 and the retro-reflective screen 9, a half mirror is arranged as an optical element 10 at an angle of 45 degrees with the 3-dimensional image display 1 and the retro-reflective screen 9. For example, the ratio of the transmitted light and the reflected light is set to 1:1, and a horizontal width is set to 896.0 mm which is 0.2 times of the retro-reflective screen 9.

In such a structure, when the 3-dimensional spatial image is observed from the position shown in FIG. 2, the 3-dimensional spatial image 12 is able to be viewed in front of the highest resolution specified on the screen of the 3-dimensional image display 1 in the area against the background of the retro-reflective screen 9 of a virtual image which appears over the half mirror.

After the second embodiment, for simplification of explanation, it is explained as screen width=display width, but the screen width and the element image width may be defined according to formulas (1)-(9), when the viewing area of the 3-dimensional spatial image 12 is maximized.

However, from the relation of an arrangement space, also when it must arrange by screen width=display width, although a screen width is insufficient, it may calculate for element image width according to formula (9), for simplification, it can also create the element image as an element image width=an aperture pitch (w=pe).

In such a case, although the viewing area in the 3-dimensional image 12 becomes narrow (it is easy to mix a false image), the viewing area is secured at the minimum by satisfying the relation of w<=pe at least.

### Second Embodiment

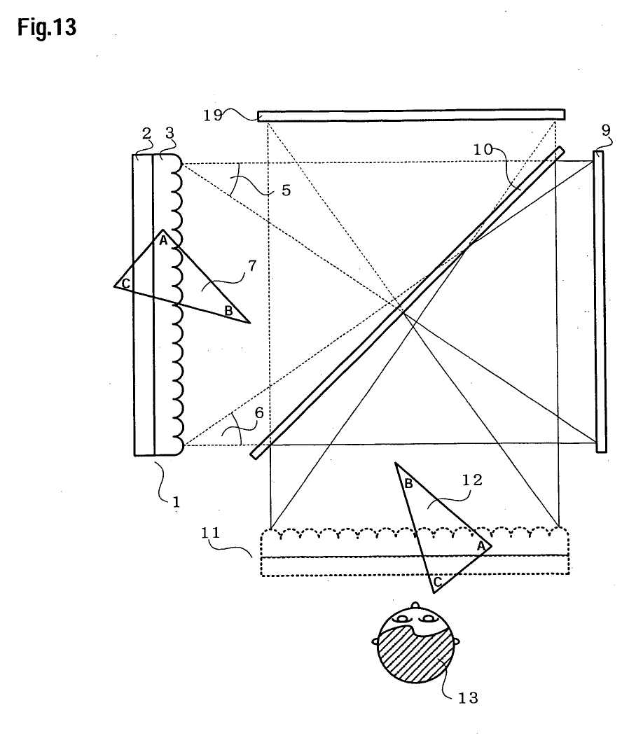

A three-dimensional spatial image display apparatus according to the second embodiment will be described below in detail with reference to FIG. 13. FIG. 13 shows how to improve the brightness of the 3-dimensional spatial image 12, when a half mirror is used as an optical element 10. For example, if it is assumed that the rate of the transmitted light and the reflection light of the half mirror is 50%, the rate of reflection of the retro-reflective screen 9 is 70%, theoretically, and the brightness falls to 17.5% of the original 3-dimensional image 7, since the brightness of the 3-dimensional spatial image 12 decreases to 50% by passing the half mirror 10, the brightness is further decreased to 70% by reflecting on the retro-reflective screen 9, and decreases to 50% by reflecting in the half mirror 10 further again. If the transmission ratio and the reflection ratio of the half mirror 10 are ideally 100% by using a polarizing prism, the brightness of the 3-dimensional spatial image 12 may consider only the brightness loss of reflection of the retro-reflective screen 9, and the brightness of the 3-dimensional spatial image 12 should rise to 70%.

As shown in FIG. 13, the 1st retro-reflective screen 9 is provided in the direction in which the light rays emitted from the 3-dimensional image display 1 are transmitted by the optical element 10, and the 2nd retro-reflective screen 19 is provided in the direction in which the light rays further emitted from the 3-dimensional-image display 1 are reflected by the optical element 10. Thus, since the light rays which reflect in the 1st retro-reflective screen 9 and reflect in the optical element 10, and the light rays which reflect in the 2nd retro-reflective screen 19 and transmit through the optical element 10, are combined by a structure which has the 1st retro-reflective screen 9 and the 2nd retro-reflective screen 19, the brightness of the 3-dimensional spatial image 12 becomes strong, and it is effective in suppressing the brightness reduction by the optical element 10.

Since the retro-reflective screens 9 and 19 retro-reflect the light rays, even if the positions of the screens are not strictly adjusted, if the viewing area 4 of the 3-dimensional image display 1 is stabilized, the light rays which form the 3-dimensional spatial image 12 return to the position of the image correctly.

### Third Embodiment

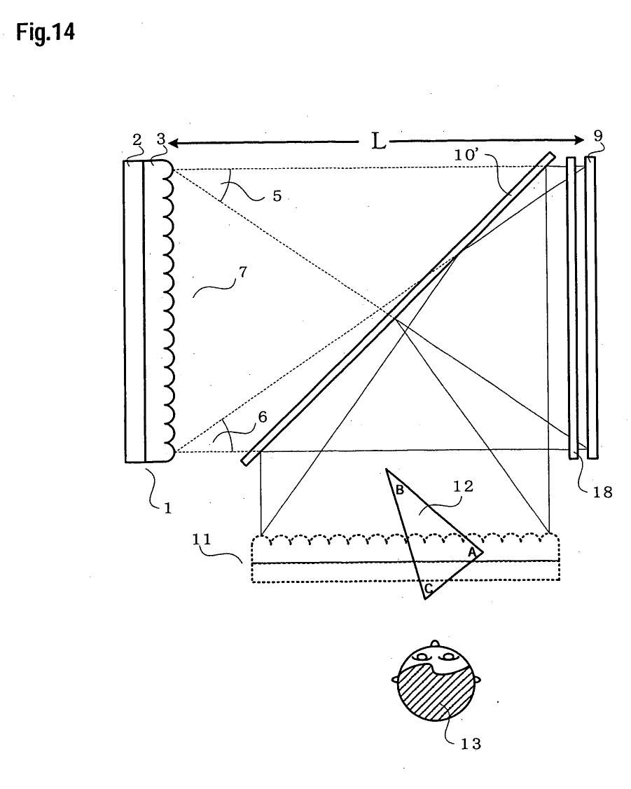

A three-dimensional spatial image display apparatus according to the third embodiment will be described below in detail with reference to FIG. 14. As a means to increase the brightness other than the composition of the second embodiment, the composition which uses a DBEF (Dual Brightness Enhancement Film) board 10′ is shown in FIG. 14 instead of the half mirror. The DBEF board transmits one side of P wave and S wave, and reflects the other side.

In addition, a λ/4 board 18 is arranged in front of the retro-reflective screen 9. According to the arrangement, the linearly polarized light rays emitted from the 2-dimensional image display 2 (LCD panel etc.) pass the DBEF board 10′, the phase shifts only λ/2 in the optical path reflected in retro-reflective screen 9. Since the polarization direction perpendicularly intersects 90 degrees from the origin by the phase shift, all the light rays are reflected in the DBEF board 10′ theoretically, and the 3-dimensional spatial image is formed. In this brightness increasing means, the second retro-reflective screen 19 is unnecessary, and since the DBEF board 10′ is arranged in practice at the angle of 45 degrees with the 2-dimensional picture display 2 or the retro-reflective screen 9, the brightness of the 3-dimensional spatial image 12 can improve in brightness of about 70% of the original 3-dimensional image 7.

### Fourth Embodiment

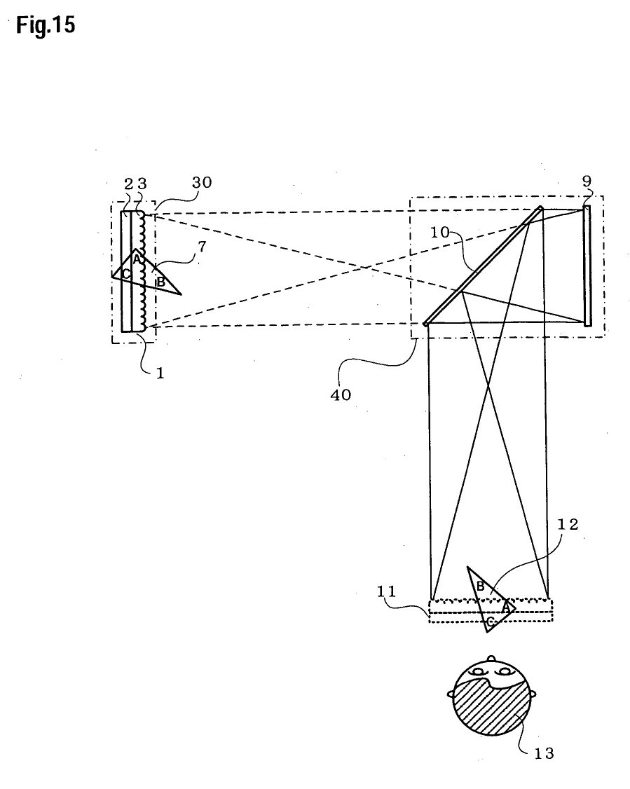

A three-dimensional spatial image display apparatus according to the fourth embodiment will be described below in detail with reference to FIG. 15. An example with an increased distance between the retro-reflective screen 9 and the 3-dimensional image display 1 as compared with FIG. 2 is shown in FIG. 15. Fundamentally, in the 3-dimensional spatial image display shown in FIG. 2. When the amount of projection from the screen of the 3-dimensional image 7 displayed on the 3-dimensional image display 1 is set to ‘da’, and the width of the 3-dimensional image display 1 is set to ‘W’, if distance between the screen of the 3-dimensional image display 1 and the reflector of the retro-reflective screen 9 is set to larger than (W+da), then the 3-dimensional spatial image display of FIG. 2 is realized. An improved sense of space can be created by making a distance between the screen of the 3-dimensional image display 1 and the reflector of the retro-reflective screen 9 larger than this. In this case, since there is a distance between 3-dimensional image display 1 and the optical element 10+the retro-reflective screen 9, as dash-dotted lines 30 and 40 showed, the apparatus may be bisected and an optical path may be arranged to the exterior of the apparatus. Thus, the arrangement can suppress the share of the space as the 3-dimensional spatial image display to the minimum. For example, the composition corresponding to the portion enclosed with the dash-dotted line 30 is arranged at the back of a wall of the room and only the portion enclosed with the dash-dotted line 40 arranged in a habitation space.

### Fifth Embodiment

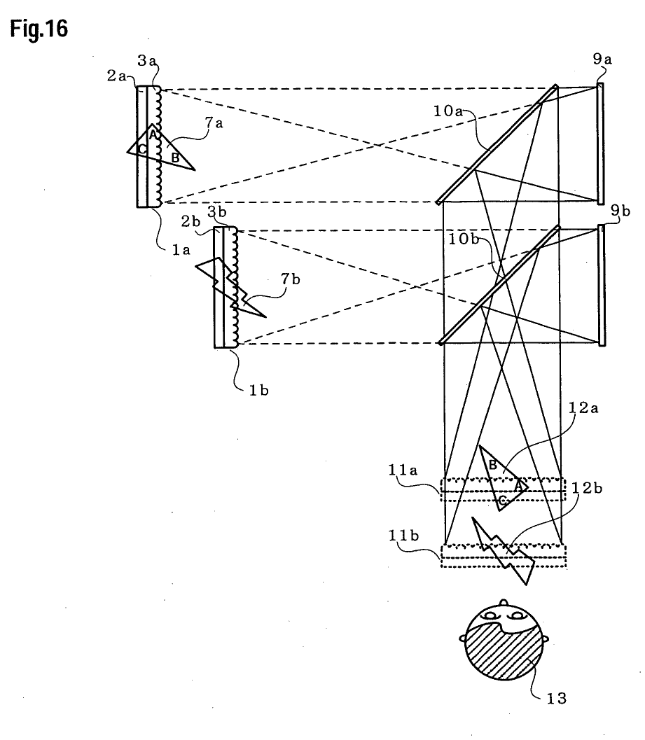

A three-dimensional spatial image display apparatus according to the fifth embodiment will be described below in detail with reference to FIG. 16. FIG. 16 showed the composition which increases the viewing area of the depth direction of the 3-dimensional spatial image 12 displayed, by combining two sets of the 3-dimensional spatial image display. Respectively, the distance between the 3-dimensional image display 1a and the retro-reflective screen 9a differs from the distance between the 3-dimensional image display 1b and the retro-reflective screen 9b, and the viewing area of the depth direction can be increased by arranging so that the direction in which the optical element 10a and the optical element 10b are reflected may be in agreement. Although the composition of two sets are showed in FIG. 16, if there is no problem in the volume as the 3-dimensional spatial image apparatus increases, the area which can be displayed can be made to increase in the depth direction from an observer 13 with high definition by increasing the number of sets.

### Sixth Embodiment

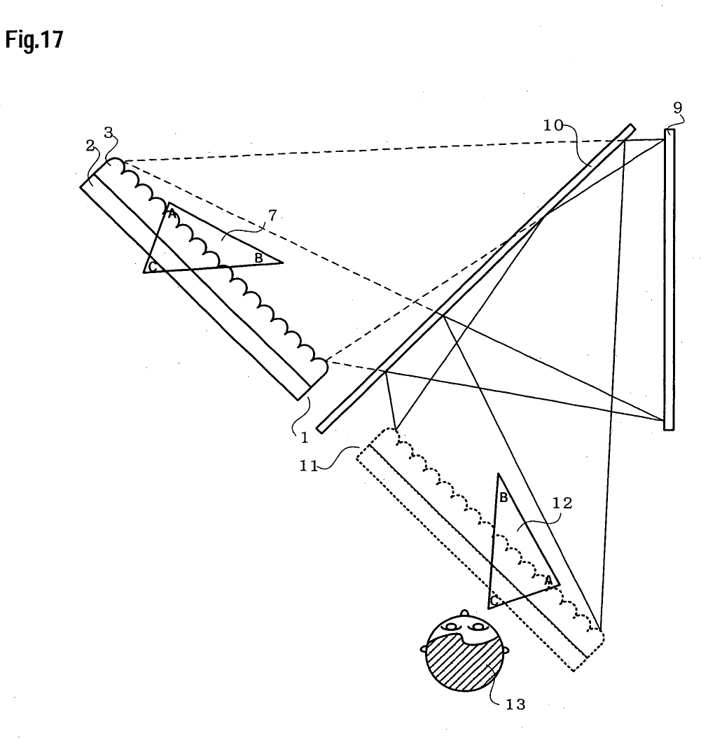

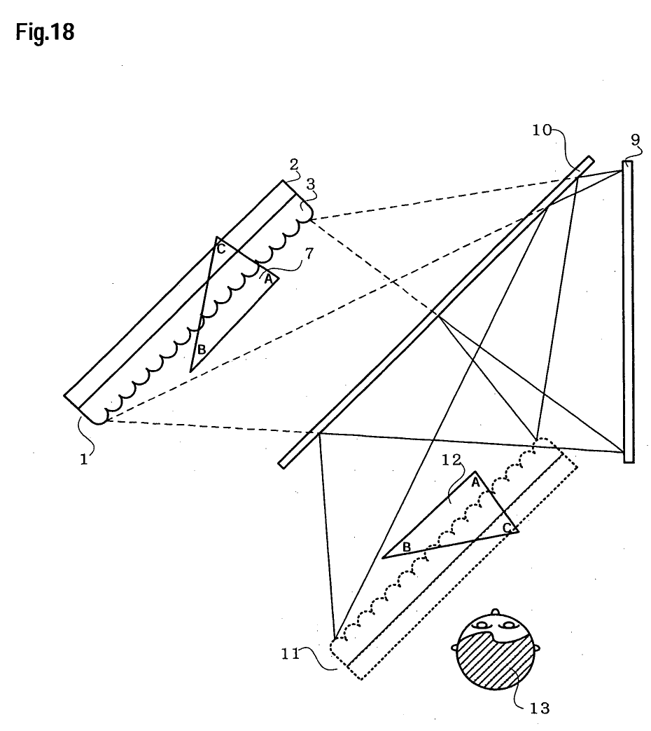

A three-dimensional spatial image display apparatus according to the sixth embodiment will be described below in detail with reference to FIGS. 17 and 18. FIG. 17 and FIG. 18 show how to arrange the area (equivalent to the position 11 of the real image of the 3-dimensional image) where the high definition of the 3-dimensional spatial image displayed with an angle to the 3-dimensional spatial image display, by changing the arrangement angle of the 3-dimensional image display 1 to the optical element 10. Thus, even if the single 3-dimensional image display 1 is used, the high definition viewing area can be distributed in the depth direction for the observer, and it becomes possible to display the 3-dimensional spatial image with a stronger sense of perspective. Although it is shown in FIG. 17 and FIG. 18 as a fixed 3-dimensional-image display 1, the 3-dimensional-image display 1 may be rotated about a screen center (direction perpendicular to paper) as an axis, and a volume display also is possible by the single panel according to axial rotation of the 3-dimensional image display 1 and its position by time sharing further so that all of the relation of FIG. 17 and FIG. 18 may be filled.

### Seventh Embodiment

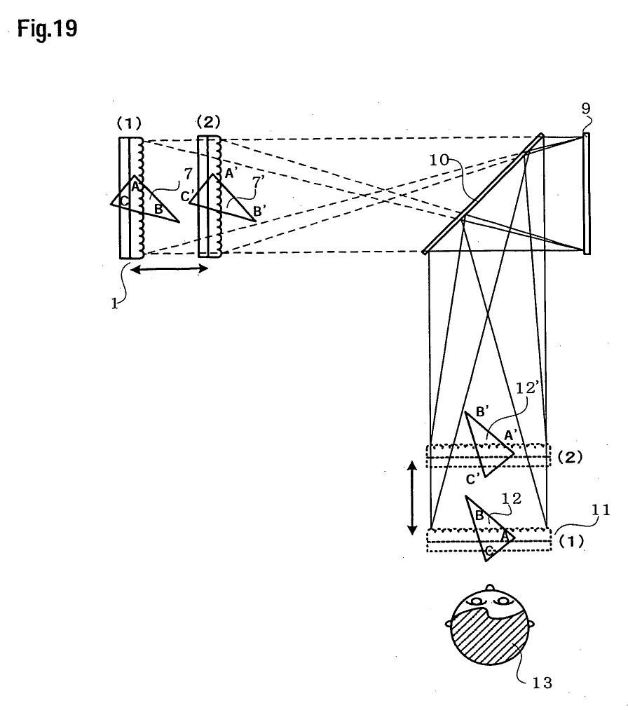

A three-dimensional spatial image display apparatus according to the seventh embodiment will be described below in detail with reference to FIG. 19. Although the composition which increases the viewing area of the depth direction by combining a plurality of sets of the 3-dimensional image display is shown in FIG. 16, as shown in FIG. 19, the moving means ((1)-(2)) to which the single 3-dimensional image display 1 is moved front and rear is provided, and it may be made to display the image (from 7 to 7′, from 12 to 12′) according to position change of this 3-dimensional image display by time sharing. The 3-dimensional spatial image can be displayed in the depth direction by high definition from the viewpoint of the observer 13 by this composition.

### Eighth Embodiment

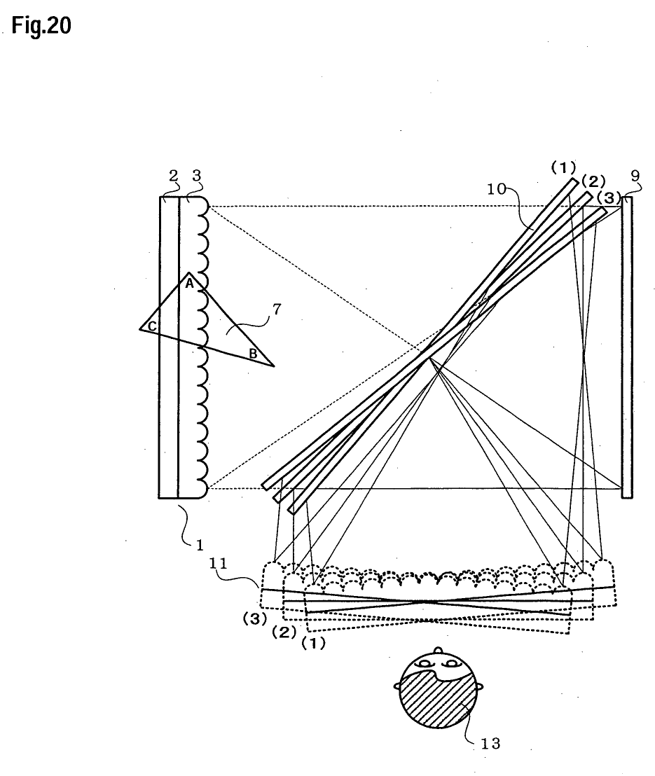

A three-dimensional spatial image display apparatus according to the eighth embodiment will be described below in detail with reference to FIG. 20. Although the composition which rotates the 3-dimensional image display 1 is shown in FIG. 17 and FIG. 18, it may be the composition which rotates ((1)-(3)) the optical element 10 as shown in FIG. 20. A depth information can be made to easily expand by this composition, without changing the apparatus of the 3-dimensional spatial image display. As mentioned above, although the composition displays a high definition 3-dimensional spatial image in the face of an observer 13 by combining the 3-dimensional-image display 1, and the optical element 10 and the retro-reflective screen 9 about the embodiment is explained, the present invention can be practiced without being limited to this.

It will be apparent to those skilled in the art that various modifications and variations can be made in the apparatus and method of the present invention and in practice of this invention without departing from the scope or spirit of the invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A three-dimensional spatial image display apparatus comprising:
a three-dimensional image display having a two-dimensional image display configured to display pixels arranged in a matrix shape, the pixels composing an elemental image, the three-dimensional image display further having a beam controlling element arranged parallel to a display surface of the two-dimensional image display and having apertures corresponding to the pixels, and wherein the three-dimensional image display is configured to display a three-dimensional image by emitting light rays from the pixels via the apertures corresponding to the pixels;
a retro-reflective screen configured to reflect the light rays along a locus of the light rays emitted from the pixels via the apertures corresponding to the pixels; and
an optical element arranged between the beam controlling element and the retro-reflective screen, and being both transmissive and reflective so as to cross the locus of the light rays.

2. A three-dimensional spatial image display apparatus according to claim 1, wherein the optical element has an optical axis dividing a transmissive portion from a reflective portion;
and further comprising a λ/4 board arranged between the optical element and the retro-reflective screen.

3. A three-dimensional spatial image display apparatus according to claim 1, wherein a size of the retro-reflective screen is equal to or wider than an observable range of the three-dimensional image displayed by the three-dimensional image display.

4. A three-dimensional spatial image display apparatus according to claim 1, wherein a distance between a display surface of the three-dimensional image display and the retro-reflective screen is larger than (W+da), when a projection amount from the display surface of the three-dimensional image displayed by the three-dimensional image display is da, and a width of the three-dimensional image display is W.

5. A three-dimensional spatial image display apparatus comprising:
a plurality of three-dimensional image displays having a two-dimensional image display configured to display pixels arranged in a matrix shape, the pixels composing an elemental image, the three-dimensional image displays further having a beam controlling element arranged parallel to a display surface of the two-dimensional image display and providing apertures corresponding to the pixels, the three-dimensional image displays configured to display a three-dimensional image by emitting light rays from the pixels via the apertures corresponding to the pixels;
a plurality of retro-reflective screens configured to reflect the light rays along a locus of the light rays emitted from each the three-dimensional image displays; and
a plurality of optical elements arranged respectively between the beam controlling element and the retro-reflective screen, and being both transmissive and reflective so as to cross the locus of the light rays,
the light rays via a plurality of the optical elements emitted to same direction.

6. A three-dimensional spatial image display apparatus according to claim 5, wherein the optical elements have an optical axis dividing a transmissive portion from a reflective portion;
and further comprising a X/4 board arranged between the optical element and the retro-reflective screen.

7. A three-dimensional spatial image display apparatus according to claim 5, wherein a size of the retro-reflective screens is equal to or wider than an observable range of the three-dimensional image displayed by the three-dimensional image display.

8. A three-dimensional spatial image display apparatus according to claim 5, wherein each distance between a display surface of the three-dimensional image display and the retro-reflective screen is larger than (W+da), when a projection amount from the display surface of the three-dimensional image displayed by the three-dimensional image display is da, and a width of the three-dimensional image display is W.

9. A three-dimensional spatial image display apparatus according to claim 1, wherein the retro-reflective screen is arranged in a direction of reflecting the light rays from the three-dimensional display by the optical element.

10. A three-dimensional spatial image display apparatus according to claim 5, wherein the retro-reflective screen is arranged in a direction of reflecting the light rays from the three-dimensional display by the optical element.

11. A three-dimensional spatial image display apparatus according to claim 1, wherein an angle between the display surface of the three-dimensional image display and a reflective surface of the optical element differs by 45 degrees.

12. A three-dimensional spatial image display apparatus according to claim 5, wherein an angle between the display surface of the three-dimensional image display and a reflective surface of the optical element differs by 45 degrees.

13. A three-dimensional spatial image display apparatus according to claim 1, further comprising a display rotator configured to change an angle between the display surface of the three-dimensional image display and a reflective surface of the optical element by movement of the three-dimensional image display.

14. A three-dimensional spatial image display apparatus according to claim 5, further comprising a display rotator configured to change an angle between the display surface of the three-dimensional image display and a reflective surface of the optical element by movement of the three-dimensional image display.

15. A three-dimensional spatial image display apparatus according to claim 1, further comprising a display shifter configured to change a distance between the display surface of the three-dimensional image display and a reflective surface of the optical element by movement of the three-dimensional image display.

16. A three-dimensional spatial image display apparatus according to claim 5, further comprising a display shifter configured to change a distance between the display surface of the three-dimensional image display and a reflective surface of the optical element by movement of the three-dimensional image display.

17. A three-dimensional spatial image display apparatus according to claim 1, further comprising an optical element rotator configured to change an angle between the display surface of the three-dimensional image display and a reflective surface of the optical element by movement of the optical element.

18. A three-dimensional spatial image display apparatus according to claim 5, further comprising an optical element rotator configured to change an angle between the display surface of the three-dimensional image display and a reflective surface of the optical element by movement of the optical element.

19. A method of displaying three-dimensional spatial image comprising:
displaying pixels arranged in a matrix shape, the pixels composing an elemental image by a
two-dimensional display, reflecting light rays emitted via an aperture of a beam controlling element arranged parallel to a display surface of the two-dimensional image display and providing apertures corresponding to the pixels, along a locus of the light rays emitted from the pixels by a retro-reflective screen;
arranging an optical element between the beam controlling element and the retro-reflective screen; and
displaying a three-dimensional image from light rays emitted via the aperture by an optical element which is both transmissive and reflective so as to cross the locus of the light rays and light rays reflected by the retro-reflective screen.
